(19) United States
(12) Patent Application Publication
(10) Pub. No.: US 2013/0190425 A1
(43) Pub. Date: Jul. 25, 2013

(54) POLYCARBONATE-POLYESTER COMPOSITIONS, METHODS OF MANUFACTURE, AND ARTICLES THEREOF

(71) Applicants: Yantao Zhu, Evansville, IN (US); Josephus Gerardus Maria van Gisbergen, Bergen op Zoom (NL); Johannes Hubertus G.M. Lohmeijer, Hoogerheide (NL); Vishvajit Juikar, Bangalore (IN); Tiahua Ding, Newburgh, IN (US)

(72) Inventors: Yantao Zhu, Evansville, IN (US); Josephus Gerardus Maria van Gisbergen, Bergen op Zoom (NL); Johannes Hubertus G.M. Lohmeijer, Hoogerheide (NL); Vishvajit Juikar, Bangalore (IN); Tiahua Ding, Newburgh, IN (US)

(21) Appl. No.: 13/353,616

(22) Filed: Jan. 19, 2012

(51) Int. Cl. C08L 63/00; C08K 5/3475; C08K 5/09; C08K 5/521; C08K 5/36

(52) U.S. Cl. 523/451; 523/436; 523/453; 523/455; 523/456

(57) ABSTRACT

A composition comprising polycarbonate, polyethylene terephthalate, organopolysiloxane-polycarbonate block copolymer, and epoxy-functional block copolymer for providing an improved balance of properties, including heat aging performance in combination with impact resistance. Articles molded from the composition are advantageously useful for automotive applications.

### BACKGROUND OF THE INVENTION

A blend of polyester with polycarbonate can offer some improvement with respect to the properties of polycarbonate or polyester alone. Polycarbonate is a useful engineering plastic for parts requiring toughness, but can be improved in regard to various other properties such as processiblity and stress crack resistance.

Polyesters can provide improved heat resistance. The addition of an impact modifier can provide further improvement of a polycarbonate-polyester composition with respect to impact behavior. Rubbers can be added to improve impact performance at low temperatures. Impact-modified thermoplastic bends that include a polyester resin, a polycarbonate resin, and a glycidyl ester impact modifier are also known. For example, U.S. Pat. Nos. 5,112,913 and 5,369,154 disclose such compositions for molding automotive components in which a glossy, defect-free surface appearance is desired. The siloxane domains of organosiloxane-polycarbonate copolymers are known to confer higher impact strength to polycarbonate-containing compositions in some cases.

While articles molded from known impact-modified polyester-polycarbonate blends can provide good impact performance, the weatherability of the articles has been found to be deficient in some applications. U.S. Pat. No. 5,981,661 discloses a thermoplastic composition comprising a blend of a polyester resin and a polycarbonate resin that is modified with an organopolysiloxane-polycarbonate, a glycidyl ester impact modifier, and a flame retarding amount of a halogenated flame retardant. Such a composition can exhibit a desired combination of flame resistance, impact resistance (especially improved low temperature impact resistance at −20° C.), and enhanced weatherability, specifically after long-term exposure to UV radiation.

U.S. Pat. No. 7,309,730 states that, while the composition of U.S. Pat. No. 5,981,661 provided enhanced weatherability properties, the high amount of glycidyl impact modifier could cause an undesirable viscosity increase through the reaction between glycidyl groups in the impact modifier and carboxy groups in polyesters. U.S. Pat. No. 7,309,730 further states that, in addition, the glycidyl impact modifier is a less effective impact modifier than core-shell type rubbers.

U.S. Pat. No. 7,309,730 discloses a polymer blend comprising a polyalkylene terephthalate, an organosiloxane-polycarbonate block copolymer, an acrylic core shell impact modifier, and titanium dioxide, which blend was been found to provide properties useful as a weatherable molding composition for articles such as enclosures for electronic equipment. Again, weatherability was concerned with long-term exposure to UV light and was based on tests in which a specimen of the composition was subjected to light in an xenon arc weatherometer.

Applicants have now found that articles molded from polyester-polycarbonate blends that originally have good impact strength can age quickly and loose much of their original impact strength after being subjected to heat aging and/or hydroaging. In particular, Applicants have found deficient impact performance after heat aging in prior art polycarbonate-polyester blends. This problem can be especially noticeable for molded articles exposed to heat, for example, housings or other components in automotive applications or the like.

Thus, there is a need for polyester-polycarbonate blends exhibiting still further improvements in weatherability, specifically weatherability with respect to heat aging. Such further improvements are especially desirable for molding compositions used to form articles that are exposed to the weather, for example, molded housings for machines or electronic devices that are used outdoors.

In view of the above, an object of the invention was to develop a polycarbonate-polyester blend that exhibits an improved balance of properties that includes improved heat aging performance with respect to impact strength, while at least maintaining other desirable properties such as low temperature ductility and hydrostability.

### SUMMARY OF THE INVENTION

Surprisingly it was found that the addition of a combination of an organopolysiloxane-polycarbonate block copolymer and an epoxy-functional block copolymer to a blend of polycarbonate and polyethylene terephthalate substantially improved the heat-aged impact performance of the composition while maintaining a desired balance of other properties. In particular, the invention is directed to a thermoplastic composition comprising, based on the total weight of the composition:

(a) 20 to 50 wt. % of polycarbonate;

(b) 15 to 50 wt. % of polyester comprising 15 to 45 wt. % of polyethylene terephthalate and 0 to 12 wt. % of polybutylene terephthalate;

(c) 20 to 35 wt. % of organopolysiloxane-polycarbonate block copolymer comprising from 10 to 40 wt. % of polydiorganosiloxane units;

(d) 2 to 20 wt. % of copolyestercarbonate;

(e) 1 to 5 wt. % of epoxy-functional block copolymer; wherein the wt. % of components (a) to (e) are based on the total weight of components (a) to (e), and the total weight of components (a) to (e) is at least 75 wt. % of the total composition;

(f) 0.1 to 10 wt. %, based on the total composition, of additives comprising at least one compound selected from the group consisting of antioxidants, light stabilizers, colorants, quenchers, and mold release agents;

(g) 0 to 15 wt. % of filler, based on the total weight of the composition.

In another embodiment, a thermoplastic composition comprises, based on the total weight of the composition:

(a) 25 to 45 wt. % of polycarbonate;

(b) 15 to 50 wt. % of polyester comprising 20 to 40 wt. % of polyethylene terephthalate and 0 to 10 wt. % polybutylene terephthalate;

(c) 20 to 30 wt. % of organopolysiloxane-polycarbonate block copolymer comprising 15 to 25 wt. % of polydiorganosiloxane units;

(d) 5 to 15 wt. % of copolyestercarbonate;

(e) 2 to 4 wt. % of epoxy-functional block copolymer comprising glycidyl methacrylate units, wherein the wt. % of components (a) to (e) are based on the total weight of components (a) to (e), and the total weight of components (a) to (e) is at least 80 wt. % of the total composition;

(f) 1 to 10 wt. % of additives comprising at least one compound selected from the group consisting of antioxidants, light stabilizers, colorants, quenchers, and mold release agents;

(g) 0 to 10 wt. % of filler, based on the total weight of the composition.

In another embodiment, a thermoplastic composition comprises, based on the total weight of the composition:

(a) 25 to 45 wt. % of bisphenol A polycarbonate;

(b) 20 to 40 wt. % of polyester comprising 20 to 30 wt. % of polyethylene terephthalate and 1 to 10 wt. % of polybutylene terephthalate;

(c) about 21 to 27 wt. % of organopolysiloxane-polycarbonate block copolymer comprising from 15 to 25 wt. % of polydiorganosiloxane units having the formula:

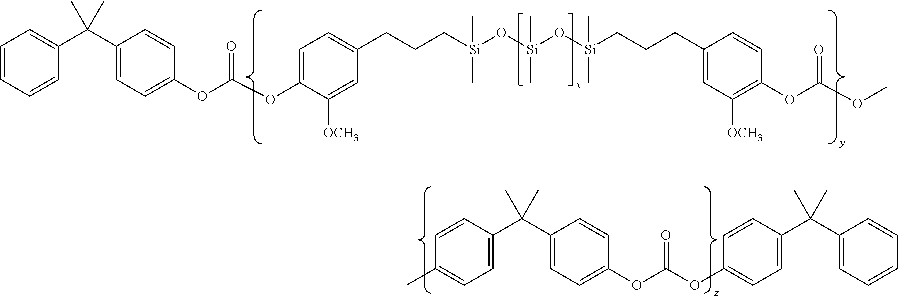

wherein x=30-50, y=1-3, and z=80-100;

(d) 5 to 15 wt. % of copolyestercarbonate;

(e) 2 to 4 wt. % of epoxy-functional block copolymer of an epoxy-functional block copolymer comprising units derived from ethylene, glycidyl methacrylate, and C₁₋₄ alkyl(meth)acrylate, wherein the wt. % of components (a) to (e) are based on the total weight of components (a) to (e), and the total weight of components (a) to (e) is at least 85 wt. % of the total composition;

(f) 2 to 10 wt. % of additives comprising at least one compound selected from the group consisting of antioxidants, light stabilizers, colorants, quenchers, and mold release agents;

(g) 0 to 10 wt. % of filler, based on the total weight of the composition.

The composition can advantageously exhibit: (i) 100% ductility in both notched Izod impact test as well as multi-axial impact test at 23° C., 0° C., and −20° C. after molding, (ii) 100% ductility in both notched Izod impact test as well as multi-axial impact test after heat aging at 140° C. for up to 1000 hours, and (iii) 100% ductility in both notched Izod impact test as well as multi-axial impact test after hydroaging at 80° C. and 80% humidity for up to 500 hours.

In one embodiment, the composition further exhibits a notched Izod impact strength of greater than 500 J/m, measured at 23° C. in accordance with ASTM D256 on a sample bar molded from the composition and having a thickness of 3.2; a notched Izod impact strength of greater than 500 μm measured at −20° C. in accordance with ASTM D256 on a sample bar molded from the composition and having a thickness of 3.2; and, after heat aging at 140° C. for up to 1000 hours, a notched Izod impact strength of greater than 500 μm measured at 23° C. in accordance with ASTM D256 on a sample bar molded from the composition and having a thickness of 3.2.

In another embodiment, an article comprises one of the above-described compositions.

### DETAILED DESCRIPTION OF THE INVENTION

The invention is based on the surprising discovery that substantially improved heat aging performance can be imparted to a polyester-polycarbonate molding composition having carefully balanced properties in terms of hydrostability, heat resistance, flow properties, impact strength, and other mechanical properties. Such a balance of properties can be obtained using a combination of an epoxy-functional impact modifier and an organopolysiloxane-polycarbonate block copolymer in the polycarbonate-polyester blend wherein the polyester comprises polyethylene terephthalate.

As used herein the singular forms “a,” “an,” and “the” include plural referents. The term “combination” is inclusive of blends, mixtures, alloys, reaction products, and the like. Unless defined otherwise, technical and scientific terms used herein have the same meaning as is commonly understood by one of skill. Compounds are described using standard nomenclature. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

All ASTM tests and data are from the 2003 edition of the Annual Book of ASTM Standards unless otherwise indicated. All cited references are incorporated herein by reference.

For the sake of clarity, the terms “terephthalic acid group,” “isophthalic acid group,” “butanediol group,” and “ethylene glycol group” have the following meanings. The term “terephthalic acid group” in a composition refers to a divalent 1,4-benzene radical (-1,4-(C₆H₄)—) remaining after removal of the carboxylic groups from terephthalic acid-. The term “isophthalic acid group” refers to a divalent 1,3-benzene radical (-(-1,3-C₆H₄)—) remaining after removal of the carboxylic groups from isophthalic acid. The “butanediol group” refers to a divalent butylene radical (—(C₄H₈)—) remaining after removal of hydroxyl groups from butanediol. The term “ethylene glycol group” refers to a divalent ethylene radical (—(C₂H₄)—) remaining after removal of hydroxyl groups from ethylene glycol. With respect to the terms “terephthalic acid group,” “isophthalic acid group,” “ethylene glycol group,” “butane diol group,” and “diethylene glycol group” being used in other contexts, e.g., to indicate the weight percent (wt. %) of the group in a composition, the term “isophthalic acid group(s)” means the group having the formula (—O(CO)C₆H₄(CO)—), the term “terephthalic acid group” means the group having the formula (—O(CO)C₆H₄(CO)—), the term diethylene glycol group means the group having the formula (—O(C₂H₄)O(C₂H₄)—), the term “butanediol group” means the group having the formula (—O(C₄H₈)—), and the term “ethylene glycol groups” means the group having formula (—O(C₂H₄)—).

The thermoplastic composition of the present invention comprises, based on the total weight of the composition 20 to 50 wt. % of polycarbonate; 15 to 50 wt. % of polyester comprising 15 to 45 wt. % of polyethylene terephthalate and 0 to 12 wt. % of polybutylene terephthalate; 20 to 35 wt. % of organopolysiloxane-polycarbonate block copolymer comprising from 10 to 40 wt. % of polydiorganosiloxane units; 2 to 20 wt. % of copolyestercarbonate; and 0.5 to 6 wt. % of epoxy-functional block copolymer, wherein the wt. % of the each component of polyester, organopolysiloxane-polycarbonate block copolymer, copolyestercarbonate, and epoxy-functional block copolymer is based on the total weight of those components, referred to as the “specified resins,” and the total weight of those specified resins is at least 75 wt. % of the total composition. The composition further comprises 0.1 to 10 wt. %, based on the total composition, of additives comprising at least one compound selected from the group consisting of antioxidants, light stabilizers, colorants, quenchers, and mold release agents, based on the total weight of the composition; and 0 to 15 wt. % of filler, based on the total weight of the composition.

As used herein, the term “polycarbonate” means compositions having at least 90 wt. %, specifically at least 95 wt. %, more specifically at least 98 wt. % of repeating structural carbonate units of formula (1)

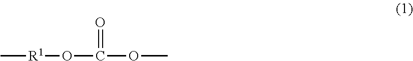

in which at least 60 percent of the total number of R¹ groups contain aromatic moieties and the balance thereof are aliphatic, alicyclic, or aromatic. The term “polycarbonate” excludes copolyestercarbonate and organopolysiloxane-polycarbonate block copolymers. In formula (1), each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Also included are aromatic dihydroxy compounds of formula (3):

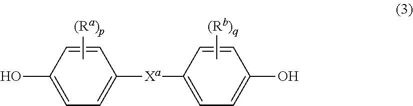

wherein R^{a} and R^{b} each represent a halogen atom or a monovalent hydrocarbon group and may be the same or different; p and q are each independently integers of 0 to 4; and X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is —C(R^{c})(R^{d})— or —C(═R^{e}) (wherein R^{c} and R^{d} each independently is a hydrogen atom or a monovalent linear or cyclic hydrocarbon group and R^{e} is a divalent hydrocarbon group), a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group. In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

Other useful aromatic dihydroxy compounds of the formula HO—R¹—OH include compounds of formula (4)

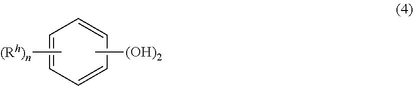

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl) methane, 1,1-bis(4-hydroxyphenyl)ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The polycarbonates can have an intrinsic viscosity, as determined in chloroform at 25° C., of about 0.3 to about 1.5 deciliters per gram (dl/g), specifically about 0.45 to about 1.0 dl/g. The polycarbonates can have a weight average molecular weight of about 10,000 to about 200,000 Daltons, specifically about 20,000 to about 100,000 Daltons, as measured by gel permeation chromatography (GPC), using a crosslinked styrene-divinylbenzene column and calibrated to polycarbonate references. GPC samples are prepared at a concentration of about 1 mg per ml, and are eluted at a flow rate of about 1.5 ml per minute. Combinations of polycarbonates of different flow properties can be used to achieve the overall desired flow property.

In one embodiment polycarbonates are based on bisphenol A, in which each of A¹ and A² is p-phenylene and Y¹ is isopropylidene. The weight average molecular weight of the polycarbonate can be about 5,000 to about 100,000 Daltons, or, more specifically about 10,000 to about 65,000 Daltons, or, even more specifically, about 15,000 to about 35,000 Daltons.

To achieve the desired properties, the polycarbonate is present in the composition in an amount from 20 wt. % to 60 wt. %, specifically 25 to 50 wt. %, more specifically 25 to 45 wt. %, based on the total weight of the polycarbonate, polyester, organopolysiloxane-polycarbonate block copolymer, copolyestercarbonate, and epoxy-functional block copolymer in the composition.

The composition comprises polyethylene terephthalate, specifically poly(1,4-ethylene terephthalate). Polyester polymers of terephthalic acid and ethylene glycol, or “PET” resin, are usually produced by one of two different processes, namely: (1) the direct esterification and then polymerization of pure terephthalic acid (TPA) with an excess of the corresponding alkanediol, e.g., ethylene glycol, or (2) transesterification of a dialkyl terephthalate, e.g., a (lower) C₁-C₆ alkyl terephthalate such as dimethylterephthalate (DMT) and ethylene glycol to form, as known in the art, “DMT monomer.”

PET may be optionally modified with other monomers, e.g., 1,4-cyclohexanedimethanol, other glycols, isophthalic acid, and other dicarboxylic acid modifiers, normally in amounts under 5 wt. %, specifically less than 2 wt. % of the polymer. Also contemplated herein is PET with minor amounts, e.g., from about 0.5 to about 5 percent by weight, of units derived from aliphatic acid and/or aliphatic polyols to form copolyesters. The aliphatic polyols include glycols, such as poly(ethylene glycol) or poly(butylene glycol). An example of a thermoplastic poly(ester-ether) (TPEE) copolymer is poly(ethylene-co-poly(oxytetramethylene) terephthalate. Such polyesters can be made following the teachings of, for example, U.S. Pat. Nos. 2,465,319 and 3,047,539.

The polyethylene terephthalate can have a weight average molecular weight of greater than or equal to 40,000 g/mol or greater, specifically 70,000 to 200,000 g/mol, against polystyrene standards, as measured by gel permeation chromatography in chloroform/hexafluoroisopropanol (5:95, volume/volume ratio) at 25° C. The polyethylene terephthalate can have an intrinsic viscosity (as measured in phenol/tetrachloroethane (60:40, volume/volume ratio) at 25° C.) of 0.5 or 0.8 to 2.0 deciliters per gram.

In another embodiment, the composition can further comprise poly(1,4-butylene terephthalate) or “PBT” resin. PBT can be obtained by polymerizing a glycol component of which at least 70 mol %, preferably at least 80 mol %, consists of tetramethylene glycol and an acid or ester component of which at least 70 mol %, preferably at least 80 mol %, consists of terephthalic acid and/or polyester-forming derivatives therefore. Commercial examples of PBT include those available under the trade names VALOX 315 and VALOX 195, manufactured by SABIC Innovative Plastics, having an intrinsic viscosity of 0.4 to about 2.0 dl/g as measured in a 60:40 phenol/tetrachloroethane mixture or similar solvent at 23°-30° C. In one embodiment, the PBT resin has an intrinsic viscosity of 0.6 to 1.4 dl/g, specifically 0.8 to 1.4 dl/g.

In general, polyesters such as polyethylene terephthalate or polybutylene terephthalate can be obtained by methods well known to those skilled in the art, including, for example, interfacial polymerization, melt-process condensation, solution phase condensation, and transesterification polymerization. Such polyester resins are typically obtained through the condensation or ester interchange polymerization of the diol or diol equivalent component with the diacid or diacid chemical equivalent component. Methods for making polyalkylene terephthalate and the use of such polyesters in thermoplastic molding compositions are known in the art. Conventional polycondensation procedures are described in the following patents, generally, U.S. Pat. Nos. 2,465,319, 5,367,011 and 5,411,999. The condensation reaction can be facilitated by the use of a catalyst, with the choice of catalyst being determined by the nature of the reactants. The various catalysts are known in the art. For example, a dialkyl ester such as dimethyl terephthalate can be transesterified with butylene glycol using acid catalysis, to generate polybutylene terephthalate. It is possible to use branched polyalkylene terephthalate in which a branching agent, for example, a glycol having three or more hydroxyl groups or a trifunctional or multifunctional carboxylic acid has been incorporated.

In one embodiment, a polybutylene terephthalate component comprises a modified polybutylene terephthalate, that is, a PBT polyester derived from poly(ethylene terephthalate), for example waste PET such as soft drink bottles. The PET-derived PBT polyester (referred to herein for convenience as “modified PBT”) (1) can be derived from a poly(ethylene terephthalate) component selected from the group consisting of poly(ethylene terephthalate), poly(ethylene terephthalate) copolymers, and a combination thereof, and (2) has at least one residue derived from the poly(ethylene terephthalate) component. The modified PBT can further be derived from a biomass-derived 1,4-butanediol, e.g., corn derived 1,4-butanediol or a 1,4-butanediol derived from a cellulosic material. Unlike conventional molding compositions containing virgin PBT (PBT that is derived from monomers), the modified PBT contains a poly(ethylene terephthalate) residue, e.g., a material such as ethylene glycol and isophthalic acid groups (components that are not present in virgin, monomer-based PBT). Use of modified PBT can provide a valuable way to effectively use underutilized scrap PET (from post-consumer or post-industrial streams) in PBT thermoplastic molding compositions, thereby conserving non-renewable resources and reducing the formation of greenhouse gases, e.g., CO₂.

Commercial examples of a modified PBT include those available under the trade name VALOX iQ PBT, manufactured by SABIC Innovative Plastics Company. The modified PBT can be derived from the poly(ethylene terephthalate) component by any method that involves depolymerization of the poly(ethylene terephthalate) component and polymerization of the depolymerized poly(ethylene terephthalate) component with 1,4-butanediol to provide the modified PBT. For example, the modified polybutylene terephthalate component can be made by a process that involves depolymerizing a poly(ethylene terephthalate) component selected from the group consisting of poly(ethylene terephthalate) and poly(ethylene terephthalate) copolymers, with a 1,4-butanediol component at a temperature from 180° C. to 230° C., under agitation, at a pressure that is at least atmospheric pressure in the presence of a catalyst component, at an elevated temperature, under an inert atmosphere, to produce a molten mixture containing a component selected from the group consisting of oligomers containing ethylene terephthalate moieties, oligomers containing ethylene isophthalate moieties, oligomers containing diethylene terephthalate moieties, oligomers containing diethylene isophthalate moieties, oligomers containing butylene terephthalate moieties, oligomers containing butylene isophthalate moieties, covalently bonded oligomeric moieties containing at least two of the foregoing moieties, 1,4-butanediol, ethylene glycol, and combinations thereof; and agitating the molten mixture at sub-atmospheric pressure and increasing the temperature of the molten mixture to an elevated temperature under conditions sufficient to form a modified PBT containing at least one residue derived from the poly(ethylene terephthalate) component.

A mixture of polyethylene terephthalates and/or polybutylene terephthalates with differing viscosities can be used to make a blend to allow for control of viscosity of the final formulation. A combination a virgin polyethylene terephthalate (polyesters derived from monomers) and virgin and/or modified poly(1,4-butylene terephthalate) obtained from recycled polyethylene terephthalate, as described above, can be used.

In one embodiment, the present composition can comprise a polyethylene terephthalate content of 15 to 50 wt. % of polyester comprising 15 to 45 wt. % of polyethylene terephthalate and 0 to 12 wt. % of polybutylene terephthalate, specifically 20 to 40 wt. % of polyethylene terephthalate, more specifically 20 to 30 wt. % of polyethylene terephthalate and 1 to 10 wt. % of polybutylene terephthalate, based on the resin components consisting of polycarbonate, polyester, organopolysiloxane-polycarbonate block copolymer, copolyestercarbonate, and carboxy-reactive block copolymer, referred to herein as the “specified resin components.”

The composition further comprises a polysiloxane-polycarbonate block copolymer, also referred to as a polysiloxane-polycarbonate. The thermoplastic compositions can comprise blends of two or more polysiloxane-polycarbonate block copolymers. These block copolymers can be transparent or translucent.

The polydiorganosiloxane (also referred to herein as “polysiloxane”) blocks of the copolymer comprise repeating diorganosiloxane units as in formula (5)

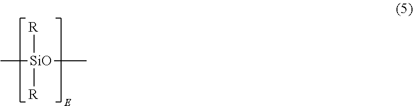

wherein each R is independently the same or different C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (5) can vary widely depending on the type and relative amount of each component in the thermoplastic composition, the desired properties of the composition, and like considerations. Generally, E has an average value of 2 to about 1,000, specifically about 2 to about 500, more specifically about 5 to about 100. In one embodiment, E has an average value of about 10 to about 75, and in still another embodiment, E has an average value of about 40 to about 60. Where E is of a lower value, e.g., less than about 40, it can be desirable to use a relatively larger amount of the polycarbonate-polysiloxane copolymer. Conversely, where E is of a higher value, e.g., greater than about 40, a relatively lower amount of the polycarbonate-polysiloxane copolymer can be used.

A combination of a first and a second (or more) polycarbonate-polysiloxane copolymers can be used, wherein the average value of E of the first copolymer is less than the average value of E of the second copolymer.

In one embodiment, the polydiorganosiloxane blocks are of formula (6)

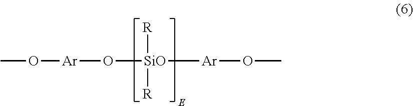

wherein E is as defined above; each R can be the same or different, and is as defined above; and Ar can be the same or different, and is a substituted or unsubstituted C₆-C₃₀ arylene group, wherein the bonds are directly connected to an aromatic moiety. Ar groups in formula (6) can be derived from a C₆-C₃₀ dihydroxyarylene compound, for example a dihydroxyarylene compound of formula (3) or (4) above. Exemplary dihydroxyarylene compounds are 1,1-bis(4-hydroxyphenyl) methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, polydiorganosiloxane blocks are of formula (7)

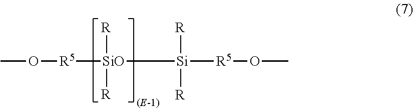

wherein R and E are as described above, and each R⁵ is independently a divalent C₁-C₃₀ organic group, and wherein the polymerized polysiloxane unit is the reaction residue of its corresponding dihydroxy compound. In a specific embodiment, the polydiorganosiloxane blocks are of formula (8):

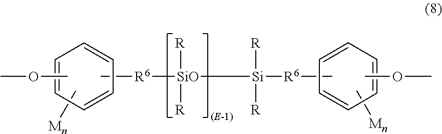

wherein R and E are as defined above. R⁶ in formula (8) is a divalent C₂-C₈ aliphatic group. Each M in formula (8) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁶ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R⁶ is a divalent C₁-C₃ aliphatic group, and R is methyl.

Blocks of formula (8) can be derived from the corresponding dihydroxy polydiorganosiloxane (9)

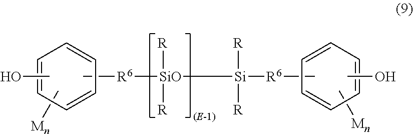

wherein R, E, M, R⁶, and n are as described above. Such dihydroxy polysiloxanes can be made by effecting a platinum-catalyzed addition between a siloxane hydride of formula (10)

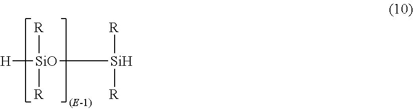

wherein R and E are as previously defined, and an aliphatically unsaturated monohydric phenol. Exemplary aliphatically unsaturated monohydric phenols include eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Combinations comprising at least one of the foregoing can also be used.

The polyorganosiloxane-polycarbonate can comprise 50 to 99 wt. % of carbonate units and 5 to 40 wt. % siloxane units. Within this range, the polyorganosiloxane-polycarbonate copolymer can comprise 10 to 30 wt. %, more specifically 15 to 25 wt. % siloxane units.

Polyorganosiloxane-polycarbonates can have a weight average molecular weight of 2,000 to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards.

The polyorganosiloxane-polycarbonate can have a melt volume flow rate, measured at 300° C./1.2 kg, of 1 to 50 cubic centimeters per 10 minutes (cc/10 min), specifically 2 to 30 cc/10 min. Mixtures of polyorganosiloxane-polycarbonates of different flow properties can be used to achieve the overall desired flow property.

Specifically, the organopolysiloxane-polycarbonate block copolymer can have the following formula (11):

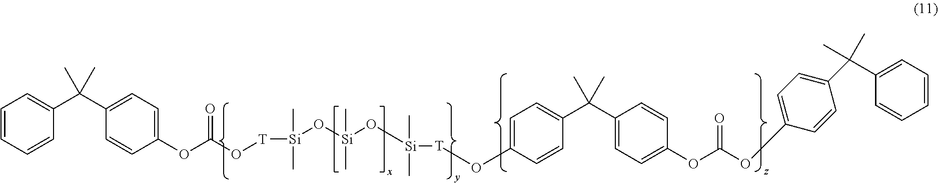

wherein x, y, and z are such that the block copolymer has 10 to 30 wt. %, specifically about 15 to 25 wt. %, more specifically about 20 wt. % of polydiorganosiloxane units. In one embodiment, x is, on average, 30-60 in formula (11). For example, on average, when x is 30-56, y can be 1-5 and z can be 70-130. T is a divalent C₃₋₃₀ linking group, specifically a hydrocarbyl group which can be aliphatic, aromatic, or a combination of aromatic and aliphatic and can contain one or more heteroatoms including oxygen. A wide variety of linking groups and combinations thereof can be used. The T group can be derived from an eugenol or allyl end-capping agent. Other end-capping agents, in addition to eugenol, include aliphatically unsaturated monohydric phenols such as 2-allyl phenol and 4-allyl-2-methylphenol.

More specifically, the organopolysiloxane-polycarbonate block copolymer can have the following formula (11a):

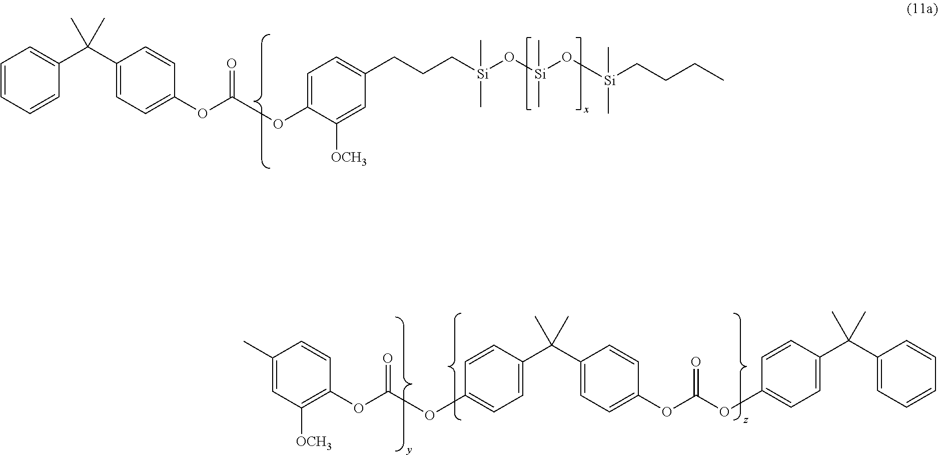

wherein x, y, and z are such that the block copolymer has 10 to 30 wt. %, specifically about 15 to 25 wt. %, more specifically about 20 wt. % of polydiorganosiloxane units. In one embodiment, x is 30-50 in formula (11). For example, when x is 30-50, y can be 1-3 and z can be 80-100. An organopolysiloxane-polycarbonate block copolymer is commercially available from Sabic Innovative Plastics under the name LEXAN EXL polycarbonate-polysiloxane copolymer, having a weight average molecular weight of about 30,000.

To achieve the desired properties, the polysiloxane-polycarbonate is present in the composition in an amount of 20 to 35 wt. %, specifically greater than 20 to less than 30 wt. %, more specifically 21 to 27 wt. %, based on the total weight of the specified resin components in the composition.

The thermoplastic composition further comprises, in an amount from 0.5 to 6.0 wt. %, specifically from 1.0 to 5.0 wt. %, still more specifically 2.0 to 4.0 wt. %, based on the total weight of the specified resin components in the composition, of an epoxy-functional block copolymer. The epoxy-functional block copolymer can comprise units derived from a C₂₋₂₀ olefin and units derived from a glycidyl(meth)acrylate. Exemplary olefins include ethylene, propylene, butylene, and the like. The olefin units can be present in the copolymer in the form of blocks, e.g., as polyethylene, polypropylene, polybutylene, and the like blocks. It is also possible to use mixtures of olefins, i.e., blocks containing a mixture of ethylene and propylene units, or blocks of polyethylene together with blocks of polypropylene.

In addition to glycidyl(meth)acrylate units, the epoxy-functional block copolymers can further comprise additional units, for example C₁₋₄ alkyl (meth)acrylate units. In one embodiment, the impact modifier is terpolymeric, comprising polyethylene blocks, methyl acrylate blocks, and glycidyl methacrylate blocks. Specific impact modifiers are a co- or terpolymer including units of ethylene, glycidyl methacrylate (GMA), and methyl acrylate, available under the trade name LOTADER® polymer, sold by Arkema. The terpolymers comprise, based on the total weight of the copolymer, 0.3 to 12 wt. % of glycidyl methacrylate units, more specifically 0.4 to 11 wt. % of glycidyl methacrylate units, even more specifically 0.5 to 10 wt. % of glycidyl methacrylate units. Suitable impact modifiers include the ethylene-methyl acrylate-glycidyl methacrylate terpolymer comprising 8 wt. % glycidyl methacrylate units available under the trade name LOTADER AX8900. Another epoxy-functional block copolymer that can be used in the composition comprises ethylene acrylate. An ELVALOY 4170 terpolymer, for example, is an ethylene-butylacrylate-glycidyl methacrylate block copolymer comprising 20 wt. % butylacrylate and 9 wt. % glycidyl methacrylate that is commercially available from DuPont.

Other unspecified polymers that can be included in the composition, in relatively minor amounts, include polyamides, polyolefins, poly(arylene ether)s, poly(arylene sulfide)s, polyetherimides, polyvinyl chlorides, polyvinyl chloride copolymers, silicones, silicone copolymers, C₁₋₆ alkyl (meth)acrylate polymers (such as poly(methyl methacrylate)), and C₁₋₆ alkyl (meth)acrylate copolymers. Such polymers are generally present in amounts of 0 to 10 wt. % of the total thermoplastic composition.

The composition further comprises a copolyestercarbonate, also known as a polyester carbonate, copolyester-polycarbonate, and a polyester-polycarbonate copolymer, having repeat units represented by the following formula (12):

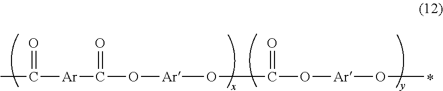

wherein Ar is a divalent aromatic residue of a dicarboxylic acid or mixture of dicarboxylic acids and each Ar′ is independently a divalent aromatic residue of a dihydric phenol or mixture of dihydric phenols, and wherein x=1-99 and y=99-1 which represents the respective moles of carbonate units and aromatic ester units.

Ar is an aryl group and preferably the residue from iso- and terephthalate or mixtures thereof. Dihydric phenols that give rise to the Ar′ groups can independently include, for example, bis-phenols such as bis-(4-hydroxy-phenyl)methane, 2,2-bis(4-hydroxyphenyl) propane (also known as bisphenol-A), 2,2-bis(4-hydroxy-3,5-dibromo-phenyl) propane; dihydric phenol ethers such as bis(4-hydroxyphenyl)ether, bis(3,5-dichloro-4-hydroxyphenyl)ether; p,p′-dihydroxydiphenyl and 3,3′-dichloro-4,4′-dihydroxydiphenyl; dihydroxyaryl sulfones such as bis(4-hydroxyphenyl)sulfone, bis(3,5-dimethyl-4-hydroxyphenyl) sulfone, dihydroxy benzenes such as resorcinol, hydroquinone; halo- and alkyl-substituted dihydroxy benzenes such as 1,4-dihydroxy-2,5-dichlorobenzene, 1,4-dihydroxy-3-methylbenzene; and dihydroxy diphenyl sulfides and sulfoxides such as bis(4-hydroxyphenyl)sulfide, bis(4-hydroxy-phenyl) sulfoxide and his (3,5-dibromo-4-hydroxy-phenyl)sulfoxide. A variety of additional dihydric phenols are available. Two or more different dihydric phenols or a combination can be employed.

The divalent residue of dihydric phenols Ar¹ can be represented by the general formula (13):

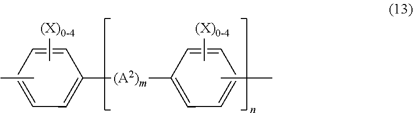

wherein A² is a divalent hydrocarbon radical containing from 1 to about 15 carbon atoms or a substituted divalent hydrocarbon radical containing from 1 to about 15 carbon atoms and substituent groups such as halogen; —S—; —S(O)₂ or —O—; each X is independently selected from the group consisting of hydrogen, halogen, and a monovalent hydrocarbon radical such as an alkyl group of from 1 to about 8 carbon atoms, an aryl group of from 6 to about 18 carbon atoms, an aralkyl group of from 7 to about 14 carbon atoms, an alkoxy group of from 1 to about 8 carbon atoms; m is 0 or 1; and n is an integer of from 0 to about 3. Ar′ may be a single aromatic ring like hydroquinone or resorcinol, or a multiple aromatic ring like biphenol or bisphenol A.

The copolyestercarbonate copolymer can also have 0 to 10 mole percent of the diol residues substituted with units of other modifying aliphatic or aromatic diols having from 2 to 16 carbons. A copolyestercarbonate copolymer can additionally contain branching agents such as tetraphenolic compounds, tri-(4-hydroxyphenyl)ethane, pentaerythritol triacrylate or others known in the art.

These polymers may be prepared by a variety of methods, for example, by either melt polymerization or by interfacial polymerization. A discussion of copolyestercarbonate resins and their synthesis is contained in chapter 10, pages 255-281, of “Engineering Thermoplastics Properties and Applications” edited by James M. Margolis, published by Marcel Dekker Inc. 1985. Generally, a dihydric phenol such as bisphenol A can be reacted with phosgene with the use of optional mono-functional compounds as chain terminators and tri-functional or higher functional compounds as branching or crosslinking agents. Another process of producing copolyestercarbonate copolymers is through ester-carbonate interchange performed by melt extrusion of polycarbonate and polyarylate.

In one embodiment, the copolyestercarbonate is prepared with aromatic dicarboxylic acids, and in particular terephthalic acid, and mixtures thereof with isophthalic acid wherein the weight ratio of terephthalic acid to isophthalic acid is in the range of from about 5:95 to about 95:5. Rather than utilizing the dicarboxylic acid per se, it is possible, and sometimes even preferred, to employ various derivatives of the acid moiety. Illustrative of these reactive derivatives are the acid halides. The preferred acid halides are the acid dichlorides and the acid dibromides. Thus, for example instead of using terephthalic acid or mixtures thereof with isophthalic acid, it is possible to employ terephthaloyl dichloride, and mixtures thereof with isophthaloyl dichloride. In one embodiment, the polyester-polycarbonate copolymer for use in the blends of the present invention is derived from reaction of bisphenol-A and phosgene with iso- and terephthaloyl chloride.

In one embodiment, at least 95 mole percent of diol units in the copolyestercarbonate copolymer is bisphenol A. The polyester-polycarbonate copolymer can also comprise about 50 to 95 mole percent, specifically 60 to 95 mole percent, more specifically 70 to 95 mole percent of aromatic dicarboxylic acid residues, and about 5 to 50 mole percent, specifically about 5 to 40 mole percent, and more specifically 5 to 30 mole percent of carbonic acid residues. In one embodiment, at least 95 mole percent of diol units in the copolyestercarbonate copolymer is bisphenol A.

In one embodiment, the aromatic diacids are selected from terephthalic acid and isophthalic acid or mixtures thereof. In another embodiment, terephthalic acid and isophthalic acid are the only diacids present in the polyester-polycarbonate copolymer. Such a copolyestercarbonate copolymer, however, can also comprise from about 0 to 20 mole percent of modifying aromatic or non-aromatic dicarboxylic acid residues. Examples of modifying diacids containing about 2 to about 20 carbon atoms that may be used include but are not limited to aliphatic dicarboxylic acids, alicyclic dicarboxylic acids, aromatic dicarboxylic acids, or mixtures of two or more of these acids. Specific examples of modifying dicarboxylic acids include, but are not limited to, one or more of succinic acid, glutaric acid, adipic acid, suberic acid, sebacic acid, azelaic acid, dimer acid, sulfoisophthalic acid.

In another embodiment, the composition can comprise a copolyestercarbonate that is a poly(isophthalate-terephthalate-resorcinol ester)-co-(bisphenol-A carbonate) polymer comprising repeating structures of formula (14):

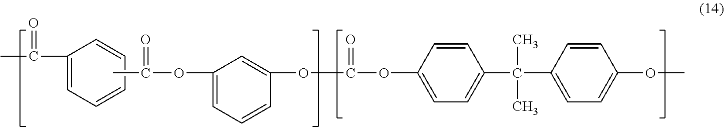

comprising from 10 to 30 wt. %, or from 15 to 25 wt. % of arylate ester units and from 70 to 90 wt. %, or from 75 to 85 wt. % of aromatic carbonate units.

Commercial examples of copolyestercarbonate copolymers include those available under the trade names LEXAN 4701, LEXAN 4703, and LEXAN 4501, manufactured by SABIC Innovative Plastics. For example, LEXAN 4701 comprises, in addition to a diol component that is 100 mole percent bisphenol A, 70 mole percent isophthalic acid, 25 mole percent carbonic acid, and 5 mole percent terephthalic acid. The copolyestercarbonates in the composition can have an inherent viscosity of at least about 0.3 dL/g, specifically 0.3 to 0.7 dl/g, and more specifically 0.4 to 0.5 dl/g, determined at 25° C. in 60/40 wt/wt phenol/tetrachloroethane.

The copolyestercarbonate copolymer is present in the composition in an amount of 2 to 20 wt. %, specifically 5 to 15 wt. %, more specifically 8 to 12 wt. %, based on the total weight of the specified resins in the composition. Within this range, the amount can be varied to achieve the desired characteristics of the composition, for example, good surface appearance. A combination of different copolyestercarbonate copolymers can be used.

The polyester-polycarbonate copolymer and the organopolysiloxane-polycarbonate block copolymer can independently comprise terminal groups derived from the reaction with a chain stopper (also referred to as a capping agent), which limits molecular weight growth rate, and so controls molecular weight in the polycarbonate. In one embodiment, the chain stoppers are monophenolic compounds of formula (15)

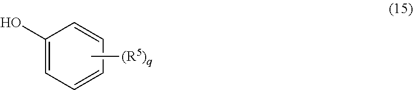

wherein each R⁵ is independently halogen, C₁₋₂₂ alkyl, C₁₋₂₂ alkoxy, C₁₋₂₂ alkoxycarbonyl, C₆₋₁₀ aryl, C₆₋₁₀ aryloxy, C₆₋₁₀ aryloxycarbonyl, C₆₋₁₀ arylcarbonyl, C₇₋₂₂ alkylaryl, C₇₋₂₂ arylalkyl, C₆₋₃₀ 2-benzotriazole, or triazine, and q is 0 to 5. As used herein, C₆₋₁₆ benzotriazole includes unsubstituted and substituted benzotriazoles, wherein the benzotriazoles are substituted with up to three halogen, cyano, C₁₋₈ alkyl, C₁₋₈ alkoxy, C₆₋₁₀ aryl, or C₆₋₁₀ aryloxy groups.

Suitable monophenolic chain stoppers of formula (15) include phenol, p-cumyl-phenol, p-tertiary-butyl phenol, hydroxy diphenyl, monoethers of hydroquinones such as p-methoxyphenol, alkyl-substituted phenols including those with branched chain alkyl substituents having 8 to 9 carbon atoms, monophenolic UV absorber such as 4-substituted-2-hydroxybenzophenone, aryl salicylate, monoesters of diphenols such as resorcinol monobenzoate, 2-(2-hydroxyaryl)benzotriazole, 2-(2-hydroxyaryl)-1,3,5-triazines, and the like. Specific monophenolic chain stoppers include phenol, p-cumylphenol, and resorcinol monobenzoate, specifically p-cumylphenol.

The composition can also include other types of chain stoppers, for example monocarboxylic acid halides, monohaloformates, and the like. Such chain stoppers can be of formula (15), wherein a —C(O)X or —OC(O)Cl group is present in place of the phenolic hydroxyl group, and X is a halogen, particularly bromine or chloride. Monocarboxylic acid chlorides and monochloroformates can be specifically mentioned. Exemplary monocarboxylic acid chlorides include monocyclic, monocarboxylic acid chlorides such as benzoyl chloride, C₁₋₂₂ alkyl-substituted benzoyl chloride, 4-methylbenzoyl chloride, halogen-substituted benzoyl chloride, bromobenzoyl chloride, cinnamoyl chloride, 4-nadimidobenzoyl chloride, and mixtures thereof; polycyclic, monocarboxylic acid chlorides such as trimellitic anhydride chloride, and naphthoyl chloride; and mixtures of monocyclic and polycyclic monocarboxylic acid chlorides. Chlorides of aliphatic monocarboxylic acids with up to 22 carbon atoms are suitable. Functionalized chlorides of aliphatic monocarboxylic acids, such as acryloyl chloride and methacryloyl chloride, are also suitable. Monochloroformates include monocyclic monochloroformates, such as phenyl chloroformate, alkyl-substituted phenyl chloroformate, p-cumylphenyl chloroformate, toluene chloroformate, and mixtures thereof. A combination of different chain stoppers can be used, for example a combination of two different monophenolic chain stoppers or a combination of a monophenolic chain stopper and a monochloroformate chain stopper.

The type and amount of chain stopper used in the manufacture of the copolyestercarbonate or organopolysiloxane-polycarbonate block copolymers can be selected to provide copolymers having an M_{w} of 1,500 to 100,000 Daltons, specifically 1,700 to 50,000 Daltons, and more specifically 2,000 to 40,000 Daltons. Molecular weight determinations are performed using gel permeation chromatography, using a crosslinked styrene-divinylbenzene column and calibrated to bisphenol-A polycarbonate references. Samples are prepared at a concentration of 1 milligram per milliliter, and are eluted at a flow rate of 1.0 milliliter per minute.

The composition can optionally include particulate fillers, for example, alumina, amorphous silica, anhydrous alumino silicates, mica, wollastonite, barium sulfate, zinc sulfide, clays, talc, and metal oxides such as titanium dioxide, carbon nanotubes, vapor grown carbon nanofibers, tungsten metal, barites, calcium carbonate, milled glass, flaked glass, ground quartz, silica, zeolites, and solid or hollow glass beads or spheres, and fibrillated tetrafluoroethylene. Reinforcing fillers can also be present. Suitable reinforcing fillers include fibers comprising glass, ceramic, or carbon, specifically glass that is relatively soda free, more specifically fibrous glass filaments comprising lime-alumino-borosilicate glass, which are also known as “E” glass. The fibers can have diameters of 6 to 30 micrometers. The fillers can be treated with a variety of coupling agents to improve adhesion to the polymer matrix, for example with amino-, epoxy-, amido- or mercapto-functionalized silanes, as well as with organometallic coupling agents, for example, titanium or zirconium based compounds. Particulate fillers, if present, are used in amounts effective to provide the desired effect (e.g., titanium dioxide in an amount effective to provide ultraviolet light resistance), for example, 0.1 to 15 wt. % of the total thermoplastic composition. Fibrous fillers, if present, are used in amounts effective to provide the desired effect (e.g., strength), without significantly adversely affecting other desired properties of the composition. In one embodiment, fillers are present in an amount of 0 to 10 wt. % of the total thermoplastic composition, specifically less than 5 wt. %, based on weight of the total thermoplastic composition. In one embodiment, the composition comprises no glass fibers.

In addition to the polycarbonates, polyesters, and other specified resins, the composition can include various additives ordinarily incorporated with compositions of this type, with the proviso that the additives are selected so as not to significantly adversely affect the desired properties of the composition. Mixtures of additives can be used. Exemplary additives include fillers, catalysts (for example, to facilitate reaction between an impact modifier and the polyester), antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. The foregoing additives (except any fillers) are generally present in an amount from 0.5 to 10 wt. %, specifically 1 to 10 wt. %, more specifically 2 to 5 wt. % based on the total weight of the composition. In one embodiment, the composition consists of the specified resins, optional filler, and additives, wherein the total amount of additives is not more than 10 wt. %, specifically not more than 5 wt. % based on the total weight of the composition. In one embodiment, essentially no fire retardants agents, specifically no halogenated flame retardants, are present in the composition.

In one embodiment, additives include a quencher such as an acid interchange quencher, a compound having an epoxy functionality, an antioxidant, a heat stabilizer, a light stabilizer, an ultraviolet light absorber, a plasticizer, a mold release agent, a lubricant, an antistatic agent, a pigment, a dye, a flame retardant, a gamma stabilizer, or a combination comprising at least one of the foregoing additives. Each of the foregoing additives, when present, is used in amounts typical for polyester-polycarbonate blends, for example 0.001 to 5 wt. % of the total weight of the blend, specifically 0.01 to 2 wt. % of the total weight of the blend.

Exemplary quenchers include zinc phosphate, mono zinc phosphate, phosphorous acid, phosphoric acid diluted in water, sodium acid pyrophosphate, tetrapropylorthosilicate, tetrakis-(2-methoxyethoxy)silane), sodium lauryl sulphate, boric acid, citric acid, oxalic acid, a cyclic iminoether containing compound, and combinations thereof.

The composition can comprise one or more colorants such as a pigment and/or dye additive. Suitable pigments include, for example, inorganic pigments such as metal oxides and mixed metal oxides such as zinc oxide, titanium dioxides, iron oxides or the like; sulfides such as zinc sulfides, or the like; aluminates; sodium sulfo-silicates, sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Blue 15:4, Pigment Blue 28, Pigment Green 7, Pigment Yellow 147 and Pigment Yellow 150, or combinations comprising at least one of the foregoing pigments. Pigments can be used in amounts of 0.01 to 10 wt. %, based on the total weight of the composition.

The composition can further comprise an antioxidant. Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearylpentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)propionic acid with monohydric or polyhydric alcohols; esters of beta-(5-tert-butyl-4-hydroxy-3-methylphenyl)propionic acid with monohydric or polyhydric alcohols; esters of thioalkyl or thioaryl compounds such as distearyl thiopropionate, dilauryl thiopropionate, ditridecyl thiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)propionic acid or the like, or combinations comprising at least one of the foregoing antioxidants. Antioxidants can be used in amounts of 0.0001 to 1 wt. %, based on the total weight of the composition.

Plasticizers, lubricants, and/or mold release agents additives can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate, the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 wt. %, specifically 0.01 to 0.75 wt. %, more specifically 0.1 to 0.5 wt. %, based on the total weight of the composition.

To prepare the composition of the invention, the components can be mixed by any known methods. Typically, there are two distinct mixing steps: a premixing step and a melt mixing (“melt blending”) step. In the premixing step, the dry ingredients are mixed together. The premixing is typically performed using a tumbler mixer or ribbon blender. However, if desired, the premix may be manufactured using a high shear mixer such as a Henschel mixer or similar high intensity device. The premixing is typically followed by melt mixing in which the premix is melted and mixed again as a melt. Alternatively, the premixing may be omitted, and raw materials may be added directly into the feed section of a melt mixing device, preferably via multiple feeding systems. In melt mixing, the ingredients are typically melt kneaded in a single screw or twin screw extruder, a Banbury mixer, a two roll mill, or similar device. The examples are extruded using a twin screw type extruder, where the mean residence time of the material is from about 20 seconds to about 30 seconds, and where the temperature of the different extruder zones is from about 230° C. to about 290° C.

In a specific embodiment, the compositions are prepared by blending the components of the composition by placing into an extrusion compounder to produce molding pellets. The components are dispersed in a matrix in the process. In another procedure, the components and reinforcing filler are mixed by dry blending, and then fluxed on a mill and comminuted, or extruded and chopped. The composition and any optional components can also be mixed and directly molded, e.g., by injection or transfer molding techniques. Preferably, all of the components are freed from as much water as possible. In addition, compounding is carried out to ensure that the residence time in the machine is short; the temperature is carefully controlled; the friction heat is utilized; and an intimate blend between the components is obtained.

The components can be pre-compounded, pelletized, and then molded. Pre-compounding can be carried out in conventional equipment. For example, after pre-drying the composition (e.g., for four hours at 120° C.), a single screw extruder can be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) can be fed downstream. In either case, a generally suitable melt temperature will be 230° C. to 300° C. The pre-compounded composition can be extruded and cut up into molding compounds such as conventional granules, pellets, and the like by standard techniques. The composition can then be molded in any equipment conventionally used for thermoplastic compositions, such as a Newbury or van Dorn type injection molding machine with conventional cylinder temperatures, at 230° C. to 280° C., and conventional mold temperatures at 55° C. to 95° C.

The inventors have found that a useful balance of properties can be obtained using the above-described composition, including a polyethylene terephthalate, a polycarbonate, a copolyestercarbonate, an organopolysiloxanes-polycarbonate block copolymer, and epoxy-functional block copolymer. Such blends have excellent impact resistance, low temperature ductility, together with excellent melt flow and heat resistance and additionally exhibits improved heat-aged and hydroaged impact performance.

In particular, the addition of the an organopolysiloxanes-polycarbonate block copolymer and epoxy-functional block copolymer to the composition can advantageously provide an article made from the composition exhibiting: (i) 100% ductility in both notched Izod impact test as well as multi-axial impact test at 23° C., 0° C., and −20° C. after molding, (ii) 100% ductility in both notched Izod impact test as well as multi-axial impact test after heat aging at 140° C. for up to 1000 hours, and (iii) 100% ductility in both notched Izod impact test as well as multi-axial impact test after hydroaging at 80° C. and 80% humidity for up to 500 hours.

In one embodiment, the composition further exhibits a notched Izod impact strength of greater than 500 J/m, specifically greater than 600 J/m, more specifically greater than 700 μm measured at 23° C. in accordance with ASTM D256 on a sample bar molded from the composition and having a thickness of 3.2; a notched Izod impact strength of greater than 500 J/m, specifically greater than 400 J/m, more specifically greater than 500 μm measured at −20° C. in accordance with ASTM D256 on a sample bar molded from the composition and having a thickness of 3.2; and, after heat aging at 140° C. for up to 1000 hours, a notched Izod impact strength of greater than 500 J/m, specifically greater than 540 Jim, measured at 23° C. in accordance with ASTM D256 on a sample bar molded from the composition and having a thickness of 3.2.

The compositions include embodiments that can also exhibit one or more of the following properties: a melt viscosity of greater than 500 Pa·s and a heat deflection temperature (HDT) of at least 99° C.

Specifically, in one embodiment of a thermoplastic composition comprising, based on the total weight of the composition:

(a) 25 to 45 wt. % of bisphenol A polycarbonate;

(b) 20 to 40 wt. % of polyester comprising 20 to 30 wt. % of polyethylene terephthalate and 1 to 10 wt. % of polybutylene terephthalate;

(c) about 21 to 27 wt. % of organopolysiloxane-polycarbonate block copolymer comprising from 15 to 25 wt. % of polydiorganosiloxane units having the formula:

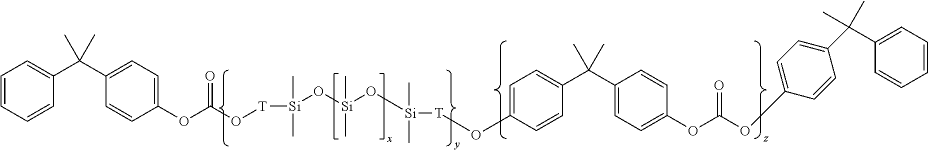

wherein x=30-60, y=1-5, and z=70-130 and T is a C₃₋₃₀ divalent organic linking group;

(d) 5 to 15 wt. % of copolyestercarbonate;

(e) 2 to 4 wt. % of epoxy-functional block copolymer of a carboxy reactive impact modifier comprising units derived from ethylene, glycidyl methacrylate, and C₁₋₄ alkyl (meth)acrylate, wherein the wt. % of components (a) to (e) is based on the total weight of components (a) to (e), and the total weight of components (a) to (e) is at least 85 wt. %, specifically at least 90 wt. %, of the total composition;

(f) 2 to 5 wt. % of additives comprising at least one compound selected from the group consisting of antioxidants, light stabilizers, colorants, quenchers, and mold release agents, based on the total weight of the composition;

(g) 0 to 10 wt. % of filler, based on the total weight of the composition, an article made from the composition exhibits: (i) 100% ductility in both notched Izod impact test as well as multi-axial impact test at 23° C., 0° C., and −20° C. after molding, (ii) 100% ductility in both notched Izod impact test as well as multi-axial impact test after heat aging at 140° C. for up to 1000 hours, and (iii) 100% ductility in both notched Izod impact test as well as multi-axial impact test after hydroaging at 80° C. and 80% humidity for up to 500 hours.

The compositions can be shaped into an article by various techniques known in the art such as injection molding, extrusion, injection blow molding, gas assist molding. The compositions are thus useful in a variety of applications, for example, in the manufacture of electrical or electronic parts, including computer and business machine housings, handheld electronic device housings such as housings for cell phones, electrical connectors, and components of light fixtures, ornaments, home appliances, roofs, greenhouses, sun rooms, swimming pool enclosures and the like. The composition can be advantageously used for molded components, for example, housings subject to an outside environment or heat exposure during use, for example housings or other components in automotive vehicles, including trucks, construction machinery, and the like.

This invention is further illustrated by the following Examples, which are not intended to limit the claims.

### EXAMPLES

### Materials

The materials used in the Examples are shown in Table 1, specifically the following materials are used in Examples 1 to 4 (i.e., E1 to E4) and Comparative Examples 1 to 12 (i.e., CE1 to CE12). Table 1 shows the nomenclature used as well as a description.

TABLE 1

| COMPONENT | CHEMICAL DESCRIPTION | SOURCE, VENDOR |
|---|---|---|
| PC | Bisphenol A Polycarbonate, | LEXAN ML8199 from |
| | CAS #111211-39-3, MW | SABIC INNOVATIVE |
| | ~22000 using PC Standard | PLASTCS |
| PET | Polyethylene Terephthalate, | INVISTA ARL |
| | Intrinsic Viscosity: 0.84 dl/g | |
| PBT | Poly(1,4-butylene | VALOX 315 |
| | Terephthalate), Intrinsic | SABIC INNOVATIVE |
| | Viscosity Of 1.2 dl/g | PLASTCS |
| PC-Siloxane | 20% PC-Siloxane Block | EXL PC from |
| Copolymer | Copolymer, PCP End-capped | SABIC INNOVATIVE |
| | MW~30,000 g/mole | PLASTCS |
| PC-PE | Copolyestercarbonate, CAS | LEXAN 4701R from |
| | #71519-80-7, MW ~28500 | SABIC INNOVATIVE |
| | using PC Standard (75% | PLASTCS |
| | ester and 25% carbonate) | |
| E-MA-GMA | Masterbatch of Epoxy- | LOTADER AX 8900 |
| Concentrate | Functional Terpolymer, 20% | from ELF ATOCHEM |
| | LOTADER AX 8900 and | |
| | 80% PC | |
| MBS | MBS (butadiene-styrene- | PARALOID EXL369 |
| | methacrylate core-shell | from DOW CHEMICAL |
| | rubber) Pellets (CAS | |
| | #9002-84-2) | |
| Anti-Oxidant | Pentaerythritol | SEENOX 412S from |
| | Betalaurylthiopropionate | HARUNO SANGYO |
| MZP | Mono Zinc Phosphate | BUDENHEIM USA, |
| | | INC |
| Light Stabilizer | 2-(2′hydroxy-5-t-octylphenyl)- | UV 5411 from |
| | benzotriazole | CIBA SPECIALITY |
| PETS | Pentaerythritol Tetrastearate | LONZA INC |
| | (mold release agent) | |
| | (CAS #115-83-3) | |
| PEPQ | Phosphonous Acid Ester | CLARIANT |
| HINDERED | Pentaerythritol-Tetrakis(3- | CIBA SPECIALITY |
| PHENOL | (3,5-di-tert.Butyl-4-hydroxy- | |
| STABILIZER | phenyl)-propionate) | |
| | (CAS #6638-19-5) | |
| Colorants | Colorant Package | SABIC INNOVATIVE |
| | | PLASTCS |

### Techniques/Procedures

The compositions used in the Examples were compounded on a 27-mm twin screw extruder with a vacuum vented mixing screw, at a barrel and die head temperature between 240 and 265° C., and a screw speed of 150 to 300 rpm. The extruder had eight independent feeders, and can be operated at a maximum rate of 300 pounds per hour. The twin-screw extruder had enough distributive and dispersive mixing elements to produce good mixing between the polymer compositions. The extrudate was cooled through a water bath, and then pelletized. The compositions were subsequently molded according to ASTM on an Engel injection-molding machine with a set temperature of approximately 240 to 290° C. The pellets were dried for 3 to 4 hours at approximately 80° C. in a forced-air circulating oven prior to injection molding. It will be recognized by one skilled in the art that the method is not limited to these temperatures or to this apparatus.

### Testing Processes/Techniques

A synopsis of all the relevant tests and test methods is given in Table 2.

Flexural properties were measured using ASTM 790 method: 3-point loading, 3.2 mm test bar thickness with a crosshead speed of 1.27 mm/min.

Tensile properties were tested according to ASTM D638 at 23° C. with a crosshead speed of 50 mm/min

Heat Deflection Temperature was tested on five bars having the dimensions 5×0.5×0.125 inches (127×12.7×3.2 mm) using ASTM method D648.

Capillary viscosity, which is indicator of melt-flow was measured by ISO D11433. Dried pellets were extruded through a capillary Rheometer and the force at varied shear rates was determined to estimate the shear viscosity. Viscosity value at 265° C. and at shear rate of 645 l/s was reported.

Izod notched impact (“INI”) was measured according to ASTM D256 at various temperatures (23° C., 0° C., and −20° C.) at pendulum energy of 5 lbf/ft.

Multiaxial impact (Dynatup Impact) testing, sometimes referred to as instrumented impact testing, was done as per ASTM D3763 using a 4×⅛ inch (101.6×3.2 mm) molded discs at various temperatures (23° C., 0° C., and −20° C.). The total energy absorbed by the sample was reported as J.

Heat aging the test samples was accomplished by heating them at 140° C. for 500 to 1000 hours. The samples were then allowed to cool to 23° C., and the notched Izod and Multiaxial impact after heat aging was measured as described above.

Izod bars (notched) and multiaxial disks were aged in an oven with controlled relative humidity of 80% and controlled temperature of 80° C. Specimens were drawn from the over after 500 hours. The samples were then allowed to cool to 23° C. and then tested as described above.

TABLE 2

| | Test Standard | Default Specimen Type | Units |
|---|---|---|---|
| ASTM Flexural Test | ASTM D790 | Bar - 127 × 12.7 × 3.2 mm | MPa |
| ASTM HDT Test | ASTM D648 | Bar - 127 × 12.7 × 3.2 mm | ° C. |
| ASTM Tensile Test | ASTM D638 | ASTM Type I Tensile bar | MPa |
| ASTM Izod Test | Notched | Bar - 63.5 × 12.7 × 3.2 mm | J/m |
| | ASTM D256 | | |
| ASTM Multiaxial | ASTM D3763 | Disk - 101.6 mm dia × | J |
| Impact | | 3.2 mm thick | |

### Examples 1-4; Comparative Examples 1-6

In Examples 1-4, a polycarbonate and poly(ethylene) ester composition was made containing a combination of organopolysiloxane-polycarbonate block copolymer and a random terpolymer of ethylene (E), methyl acrylate (MA) and glycidyl methacrylate (GMA) (E-MA-GMA copolymer) with the purpose to evaluate their performance with regard to the following properties: (i) notched Izod impact and multi-axial impact performance at 23° C., 0° C., and −20° C., (ii) notched Izod impact and multi-axial impact performance after heat aging at 140° C. for up to 1000 hours, and (iii) notched Izod impact and multi-axial impact performance after hydro aging at 80° C. and 80% humidity for up to 500 hours. These compositions were evaluated to determine whether they certain minimum targeted performance properties, namely: (a) 100% ductility in both notched Izod impact test as well as multi-axial impact test at 23° C., 0° C., and −20° C. after molding, (b) 100% ductility in both notched Izod impact test as well as multi-axial impact test after heat aging at 140° C. for up to 1000 hours, and (c) 100% ductility in both notched Izod impact test as well as multi-axial impact test after hydroaging at 80° C. and 80% humidity for up to 500 hours.

The purpose of Comparative Examples 1-8 was to compare the performance properties of the compositions of Examples 1-4 with (i) a polycarbonate and poly(alkylene ester) composition that did not contain any organopolysiloxane-polycarbonate block copolymer or random terpolymer of ethylene (E), methyl acrylate (MA) and glycidyl methacrylate (GMA) (Comparative Example 1) and (ii) a polycarbonate and poly(ethylene ester) composition that contained only either an organopolysiloxane-polycarbonate block copolymer or a random terpolymer of ethylene (E), methyl acrylate (MA) and glycidyl methacrylate (GMA) (Comparative Example 1 to 8). The formulation and impact properties of the polycarbonate-poly(ethylene ester) compositions (Examples 1 to 4) are shown in Table 3.

TABLE 3

| | | Target | | | | | |
|---|---|---|---|---|---|---|---|
| Item Name | | Performance | Unit | E1 | E2 | E3 | E4 |
| PC | | | % | 27.58 | 24.58 | 18.58 | 20.58 |
| PET | | | % | 20.00 | 20.00 | 20.00 | 20.00 |
| PC-Siloxane copolymer | | | % | 24.00 | 27.00 | 33.00 | 24.00 |
| PC/EMA-GMA Concentrate | | | % | 10.00 | 10.00 | 10.00 | 17.00 |
| PC-PE | | | % | 10.00 | 10.00 | 10.00 | 10.00 |
| PBT | | | % | 5.00 | 5.00 | 5.00 | 5.00 |
| MBS | | | % | 0.00 | 0.00 | 0.00 | 0.00 |
| Anti-Oxidant | | | % | 0.05 | 0.05 | 0.05 | 0.05 |
| Hindered Phenol Stabilizer | | | % | 0.15 | 0.15 | 0.15 | 0.15 |
| PEPQ | | | % | 0.10 | 0.10 | 0.10 | 0.10 |
| MZP | | | % | 0.10 | 0.10 | 0.10 | 0.10 |
| Light Stabilizer | | | % | 0.25 | 0.25 | 0.25 | 0.25 |
| PETS | | | % | 0.50 | 0.50 | 0.50 | 0.50 |
| Colorants | | | % | 2.27 | 2.27 | 2.27 | 2.27 |
| Total | | | | 100.00 | 100.00 | 100.00 | 100.00 |
| Siloxane Content | | | % | 4.8 | 5.4 | 6.6 | 4.8 |
| Epoxy-Functional Terpolymer | | | % | 2.0 | 2.0 | 2.0 | 3.4 |
| Content | | | | | | | |
| Siloxane + Terpolymer Content | | | % | 6.8 | 7.4 | 8.6 | 8.2 |
| SBR content | | | % | 0.0 | 0.0 | 0.0 | 0.0 |
| Flexural | Flexural | | MPa | 2200 | 2170 | 1960 | 2120 |
| | Modulus | | | | | | |
| | Flexural | | MPa | 83 | 83 | 76 | 81 |
| | Stress@Yield | | | | | | |
| Tensile | Modulus of | | MPa | 2090 | 2070 | 2040 | 2120 |
| | Elasticity | | | | | | |
| | Stress at Yield | | MPa | 53 | 53 | 52 | 52 |
| | Elongation at | | % | 108 | 114 | 91 | 115 |
| | Break | | | | | | |
| HDT | Deflection | | ° C. | 100 | 101 | 99 | 102 |
| | Temp. | | | | | | |
| Melt Viscosity | | | Pa · s | 549 | 562 | 586 | 633 |
| Izod Impact 23° C. | Ductility | 100 | % | 100 | 100 | 100 | 100 |
| | Impact | | J/m | 690 | 727 | 703 | 724 |
| | Strength | | | | | | |
| Izod Impact 0° C. | Ductility | 100 | % | 100 | 100 | 100 | 100 |
| | Impact | | J/m | 663 | 650 | 653 | 669 |
| | Strength | | | | | | |
| Izod Impact −20° C. | Ductility | 100 | % | 100 | 100 | 100 | 100 |
| | Impact | | J/m | 496 | 549 | 548 | 571 |
| | Strength | | | | | | |
| Multi-axial Impact | Ductility | 100 | % | 100 | 100 | 100 | 100 |
| 23° C. | Energy, Total | | J | 53.4 | 55.9 | 50.8 | 52.8 |
| Multi-axial Impact 0° C. | Ductility | 100 | % | 100 | 100 | 100 | 100 |
| | Energy, Total | | J | 57.7 | 65.1 | 55.7 | 74.5 |
| Multi-axial Impact −20° C. | Ductility | 100 | % | 100 | 100 | 100 | 100 |
| | Energy, Total | | J | 61 | 61.7 | 54.4 | 60.5 |

Heat aging 140° C., 500 Hr

| | | | | | | | |
|---|---|---|---|---|---|---|---|
| Izod Impact 23° C. | Ductility | 100 | % | 100 | 100 | 100 | 100 |
| | Impact | | J/m | 556 | 544 | 563 | 575 |
| | Strength | | | | | | |
| Multi-axial Impact | Ductility | 100 | % | 100 | 100 | 100 | 100 |
| 23° C. | Energy, Total | | J | 50.3 | 56.4 | 53.7 | 51.2 |

Heat aging 140° C., 1000 Hr

| | | | | | | | |
|---|---|---|---|---|---|---|---|
| Izod Impact 23° C. | Ductility | 100 | % | 100 | 100 | 100 | 100 |
| | Impact | | J/m | 425 | 460 | 449 | 471 |
| | Strength | | | | | | |
| Multi-axial Impact | Ductility | 100 | % | 100 | 100 | 100 | 100 |
| 23° C. | Energy, Total | | J | 51.5 | 54.8 | 52.6 | 51.9 |

Hydroaging, 80° C./80% RH, 500 Hr

| | | | | | | | |
|---|---|---|---|---|---|---|---|
| Izod Impact 23° C. | Ductility | 100 | % | 100 | 100 | 100 | 100 |
| | Impact | | J/m | 413 | 443 | 441 | 548 |
| | Strength | | | | | | |
| Multi-axial Impact | Ductility | 100 | % | 100 | 100 | 100 | 100 |
| 23° C. | Energy, Total | | J | 46.6 | 49.4 | 49.4 | 49.2 |

The formulations and impact properties of the polycarbonate-poly(ethylene ester) compositions (Comparative Examples 1 to 8) are shown in Table 4.

TABLE 4

| | | Target | | | | | | | | | |
|---|---|---|---|---|---|---|---|---|---|---|---|
| Item Name | | Performance | Unit | CE1 | CE2 | CE3 | CE4 | CE5 | CE6 | CE7 | CE8 |
| PC | | | % | 61.58 | 54.58 | 51.58 | 41.58 | 31.58 | 27.58 | 21.58 | 37.58 |
| PET | | | % | 20.00 | 20.00 | 20.00 | 20.00 | 20.00 | 20.00 | 20.00 | 20.00 |
| PC-Siloxane Copolymer | | | % | | | | | | | | 24.00 |
| EMA-GMA Concentrate | | | % | | | 10.00 | 20.00 | 30.00 | 34.00 | 40.00 | |
| PC-PE | | | % | 10.00 | 10.00 | 10.00 | 10.00 | 10.00 | 10.00 | 10.00 | 10.00 |
| PBT | | | % | 5.00 | 5.00 | 5.00 | 5.00 | 5.00 | 5.00 | 5.00 | 5.00 |
| MBS | | | % | | 7.00 | | | | | | |
| AO | | | % | 0.05 | 0.05 | 0.05 | 0.05 | 0.05 | 0.05 | 0.05 | 0.05 |
| Hindered Phenol Stabilizer | | | % | 0.15 | 0.15 | 0.15 | 0.15 | 0.15 | 0.15 | 0.15 | 0.15 |
| PEPQ | | | % | 0.10 | 0.10 | 0.10 | 0.10 | 0.10 | 0.10 | 0.10 | 0.10 |
| MZP | | | % | 0.10 | 0.10 | 0.10 | 0.10 | 0.10 | 0.10 | 0.10 | 0.10 |
| Light Stabilizer | | | % | 0.25 | 0.25 | 0.25 | 0.25 | 0.25 | 0.25 | 0.25 | 0.25 |
| PETS | | | % | 0.50 | 0.50 | 0.50 | 0.50 | 0.50 | 0.50 | 0.50 | 0.50 |
| Colorants | | | % | 2.27 | 2.27 | 2.27 | 2.27 | 2.27 | 2.27 | 2.27 | 2.27 |
| Total | | | | 100.00 | 100.00 | 100.00 | 100.00 | 100.00 | 100.00 | 100.00 | 100.00 |
| Siloxane Content | | | % | 0.0 | 0.0 | 0.0 | 0.0 | 0.0 | 0.0 | 0.0 | 4.8 |
| Epoxy-Functional | | | % | 0.0 | 0.0 | 2.0 | 4.0 | 6.0 | 6.8 | 8.0 | 0.0 |
| Terpolymer Content | | | | | | | | | | | |
| Siloxane + Terpolymer | | | % | 0.0 | 0.0 | 2.0 | 4.0 | 6.0 | 6.8 | 8.0 | 4.8 |
| Content | | | | | | | | | | | |
| SBR content | | | % | 0.0 | 5.5 | 0.0 | 0.0 | 0.0 | 0.0 | 0.0 | 0.0 |
| Flexural | Flexural | | MPa | 2590 | 2380 | 2410 | 2260 | 2140 | 2070 | 2030 | 2420 |
| | Modulus | | | | | | | | | | |
| | Flexural | | MPa | 103 | 92 | 96 | 89 | 83 | 79 | 77 | 94 |
| | Stress@Yield | | | | | | | | | | |
| Tensile | Modulus of | | MPa | 2610 | 2290 | 2390 | 2270 | 2080 | 2060 | 2010 | 2510 |
| | Elasticity | | | | | | | | | | |
| | Stress at Yield | | MPa | 66 | 60 | 61 | 56 | 52 | 51 | 50 | 60 |
| | Elongation at | | % | 24 | 87 | 92 | 128 | 133 | 133 | 96 | 40 |
| | Break | | | | | | | | | | |
| HDT | Deflection temp | | ° C. | 107 | 103 | 109 | 108 | 106 | 104 | 106 | 105 |
| Melt | | | Pa · s | 451 | 342 | 503 | 769 | 900 | 982 | 1076 | 517 |
| Viscosity | | | | | | | | | | | |
| Izod Impact | Ductility | 100 | % | 0 | 100 | 0 | 100 | 100 | 100 | 100 | 100 |
| 23° C. | Impact Strength | | J/m | 77.4 | 490 | 184 | 735 | 757 | 728 | 744 | 591 |
| Izod Impact | Ductility | 100 | % | 0 | 0 | 0 | 0 | 100 | 100 | 100 | 0 |
| 0 C | Impact Strength | | J/m | 70 | 157 | 118 | 193 | 688 | 735 | 703 | 172 |
| Izod Impact | Ductility | 100 | % | 0 | 0 | 0 | 0 | 0 | 0 | 0 | 0 |
| −20 C | Impact Strength | | J/m | 70.5 | 122 | 97.2 | 136 | 183 | 216 | 230 | 139 |
| Multi-axial | Ductility | 100 | % | 100 | 100 | 100 | 100 | 100 | 100 | 100 | 100 |
| Impact 23° C. | Energy, Total | | J | 60 | 56.3 | 63.3 | 66.2 | 64.5 | 64.5 | 59.5 | 59 |
| Multi-axial | Ductility | 100 | % | 100 | 40 | 100 | 100 | 100 | 100 | 100 | 100 |
| Impact 0 C | Energy, Total | | J | 68.1 | 65.5 | 69.8 | 66.6 | 70.3 | 68.5 | 66.7 | 61.6 |
| Multi-axial | Ductility | 100 | % | 20 | 20 | 100 | 100 | 100 | 100 | 100 | 100 |
| Impact −20 C | Energy, Total | | J | 69.3 | 62.2 | 74 | 74.6 | 71.9 | 67.9 | 63.9 | 63.1 |

Heat aging 140° C., 500 Hr

| | | | | | | | | | | | |
|---|---|---|---|---|---|---|---|---|---|---|---|
| Izod Impact | Ductility | 100 | % | 0 | 0 | 0 | 0 | 100 | 100 | 100 | 0 |
| 23° C. | Impact Strength | | J/m | 55.3 | 17.9 | 94.1 | 187 | 639 | 707 | 654 | 95.6 |
| Multi-axial | Ductility | 100 | % | 20 | 0 | 100 | 100 | 100 | 100 | 100 | 100 |
| Impact 23° C. | Energy, Total | | J | 24.6 | 1.68 | 63.2 | 66 | 66.8 | 65.1 | 64.2 | 53.8 |

Heat aging 140° C., 1000 Hr

| | | | | | | | | | | | |
|---|---|---|---|---|---|---|---|---|---|---|---|
| Izod Impact | Ductility | 100 | % | 0 | 0 | 0 | 0 | 100 | 100 | 100 | 0 |
| 23° C. | Impact Strength | | J/m | 50 | 28.8 | 83.3 | 158 | 583 | 546 | 600 | 84.2 |
| Multi-axial | Ductility | 100 | % | 0 | 0 | 40 | 80 | 100 | 100 | 100 | 100 |
| Impact 23° C. | Energy, Total | | J | 4.28 | 1.12 | 60.9 | 63.2 | 63.7 | 62.3 | 60.8 | 54.5 |

Hydroaging, 80° C./80% RH, 500 Hr

| | | | | | | | | | | | |
|---|---|---|---|---|---|---|---|---|---|---|---|
| Izod Impact | Ductility | 100 | % | 0 | 0 | 0 | 20 | 100 | 100 | 100 | 0 |
| 23° C. | Impact Strength | | J/m | 45.2 | 35.1 | 70.1 | 530 | 643 | 650 | 677 | 62.7 |
| Multi-axial | Ductility | 100 | % | 40 | 0 | 100 | 100 | 100 | 100 | 100 | 100 |
| Impact 23° C. | Energy, Total | | J | 48.3 | 2.88 | 53.7 | 53.9 | 56.9 | 55.7 | 57.2 | 49.9 |

### Discussion

The results shown in Tables 3 and 4 indicate that a polycarbonate-poly(ethylene ester) composition can be made containing a combination of organopolysiloxane-polycarbonate block copolymer and a random terpolymer of ethylene (E), methyl acrylate (MA) and glycidyl methacrylate (GMA) with desirable properties, namely, good impact properties at both room temperature and low temperatures (i.e., 0° C. and −20° C.), good retention of ductility after heat aging, and good retention of ductility after hydroaging, in comparison to a polycarbonate/poly(alkylene ester) composition that contains no organopolysiloxane-polycarbonate block copolymer or random terpolymer of ethylene (E), methyl acrylate (MA) and glycidyl methacrylate (GMA) or just one from the combination of organopolysiloxane-polycarbonate block copolymer and a random terpolymer of ethylene (E), methyl acrylate (MA) and glycidyl methacrylate (GMA). More particularly, the results of Examples 1-4 show that the inventive compositions meet the minimum targeted performance properties, namely: (a) 100% ductility in both notched Izod impact test as well as multi-axial impact test at 23° C., 0° C., and −20° C. after molding, (b) 100% ductility in both notched Izod impact test as well as multi-axial impact test after heat aging at 140° C. for up to 1000 hours, and (c) 100% ductility in both notched Izod impact test as well as multi-axial impact test after hydroaging at 80° C. and 80% humidity for up to 500 hours. The compositions of Comparative Examples 1-8 did not meet these properties.

It can be seen that in Examples E1 to E4 in Table 3, the addition of combinations of organopolysiloxane-polycarbonate block copolymer and a random terpolymer of ethylene (E), methyl acrylate (MA) and glycidyl methacrylate (GMA) (e.g., LOTADAR AX 8900 terpolymer in the form of PC/LOTADER AX8900 terpolymer concentrate) at a 34 wt. % level (E1 containing 24% PC-Siloxane and 10% PC/E-MA-GMA Conc.), 37 wt. % level (E2 containing 27% PC-Siloxane and 10% PC/E-MA-GMA Conc., 43 wt. % level (E3 containing 33 wt. % PC-Siloxane and 10% PC/E-MA-GMA Conc.), and 41 wt. % level (E4 containing 24% PC-Siloxane and 17 wt. % PC/E-MA-GMA Conc.) can achieve 100% ductility at both room temperature and low temperature (i.e., 0° C. and −20° C.) in both notched Izod impact test and multi-axial impact test. Furthermore, after 1000 hours heat aging at 140° C., E1 to E4 still remained 100% ductile in both notched Izod impact test and multi-axial impact test. In addition, after 500 hours hydroaging at 80° C. and 80% humidity, the compositions of E1 to E4 can still maintain 100% ductile in both notched Izod impact test and multi-axial impact test.

As shown in the comparative examples (Table 4), CE1 is a polycarbonate and poly(ethylene ester) composition without organopolysiloxane-polycarbonate block copolymer or a random terpolymer of ethylene (E), methyl acrylate (MA) and glycidyl methacrylate (GMA). CE2 is a polycarbonate and poly(alkylene ester) composition with 7% MBS impact modifier. CE3 to CE7 is a polycarbonate-poly(ethylene ester) composition with various amounts of a random terpolymer of ethylene (E), methyl acrylate (MA) and glycidyl methacrylate (GMA) in the form of a PC/E-MA-GMA concentrate (from 10% to 40%). CE8 is a polycarbonate and poly(ethylene ester) composition with 24% PC-Siloxane. It can be seen that when there is no PC-Siloxane or random terpolymer of ethylene (E), methyl acrylate (MA) and glycidyl methacrylate (GMA) in the polycarbonate-poly(ethylene ester) composition such as in CE1, the material shows brittle behavior in the notched Izod impact test at 23° C., 0° C., and −20° C. after molding. It shows ductile behavior at 23° C. and 0° C. and partially ductile behavior at −20° C. in multi-axial impact test after molding. After heat aging or hydroaging, CE1 did not meet the 100% ductile performance target. In the case of CE2 where 7% MBS impact modifier was used in the composition, the material failed to provide ductile behavior 0° C. and −20° C. in both the notched Izod impact test and multi-axial impact test after molding. After heat aging and hydroaging, CE1 did not meet the 100% ductile performance target either. In the compositions of CE3 to CE7, different amounts of random terpolymer of ethylene (E), methyl acrylate (MA) and glycidyl methacrylate (GMA) (in the form of PC/EMA-GMA concentrate) was used (from 10% to 40%, which corresponds to EMA-GMA terpolymer levels of from 2.0 to 8.0%). As can be seen, with the increasing amount of E-MA-GMA terpolymers, polycarbonate/poly(ethylene ester) compositions will improve in ductility in notched Izod impact testing at both 23° C. and 0° C. However, all comparison examples failed to achieve 100% ductility in the notched Izod impact test at −20° C. after molding. After heat aging and hydroaging, CES, CE6, and CE7 can meet the 100% ductility performance targets while CE3 and CE4 failed to achieve them. CE4 to CE7 also showed much increased melt viscosity, more than 20%, compared with E1 to E4, which renders CE4 to CE7 more difficult to process in injection-molding applications. CE8 contains 24% PC-Siloxane in the composition and showed 0% ductility at 0° C. and −20° C. in the notched Izod impact test. It also failed to achieve the 100% ductility performance target in the notched Izod impact test after heat aging and hydroaging. The brittle behavior of CE1 to CE8 after molding at various temperatures, especially low temperatures, as well as after heat and hydroaging limits their use in outdoor applications such as OVAD vehicles.

### Comparative Examples 9-12

The purpose of Comparative Examples 9-12 was to compare the performance of compositions containing a both an organopolysiloxane-polycarbonate block copolymer and a random terpolymer of ethylene (E), methyl acrylate (MA) and glycidyl methacrylate (GMA) (in the form of PC/E-MA-GMA concentrate) in amounts outside the inventive ranges.

Examples were prepared and tested as described above. The results for Comparative Examples CE9-CE12 are shown in Tables 5.

TABLE 5

| Item Name | | Target Performance | Unit | CE9 | CE10 | CE11 | CE12 |
|---|---|---|---|---|---|---|---|
| PC | | | % | 44.58 | 38.58 | 34.58 | 30.58 |
| PET | | | % | 20.00 | 20.00 | 20.00 | 20.00 |
| PC-Siloxane | | | % | 7.00 | 13.00 | 24.00 | 24.00 |
| PC/EMA-GMA Concentrate | | | % | 10.00 | 10.00 | 3.00 | 7.00 |
| PC-PE | | | % | 10.00 | 10.00 | 10.00 | 10.00 |
| PBT | | | % | 5.00 | 5.00 | 5.00 | 5.00 |
| MBS | | | % | | | | |
| AO | | | % | 0.05 | 0.05 | 0.05 | 0.05 |
| Hindered Phenol Stabilizer | | | % | 0.15 | 0.15 | 0.15 | 0.15 |
| PEPQ | | | % | 0.10 | 0.10 | 0.10 | 0.10 |
| MZP | | | % | 0.10 | 0.10 | 0.10 | 0.10 |
| Light Stabilizer | | | % | 0.25 | 0.25 | 0.25 | 0.25 |
| PETS | | | % | 0.50 | 0.50 | 0.50 | 0.50 |
| Colorants | | | % | 2.27 | 2.27 | 2.27 | 2.27 |
| Total | | | | 100.00 | 100.00 | 100.00 | 100.00 |
| Siloxane Content | | | % | 1.4 | 2.6 | 4.8 | 4.8 |
| Epoxy Functional Terpolymer | | | % | 2.0 | 2.0 | 0.6 | 1.4 |
| Content | | | | | | | |
| Siloxane + Terpolymer Content | | | % | 3.4 | 4.6 | 5.4 | 6.2 |
| SBR content | | | % | 0.0 | 0.0 | 0.0 | 0.0 |
| Flexural test | Flexural Modulus | | MPa | 2320 | 2310 | 2320 | 2270 |
| | Flexural | | MPa | 90 | 89 | 91 | 88 |
| | Stress@Yield | | | | | | |
| Tensile test | Modulus of | | MPa | 2230 | 2180 | 2290 | 2210 |
| | Elasticity | | | | | | |
| | Stress at Yield | | MPa | 57 | 56 | 58 | 55 |
| | Elongation at | | % | 124 | 63 | 33 | 84 |
| | Break | | | | | | |
| HDT | Deflection temp | | ° C. | 105 | 105 | 103 | 103 |
| Melt Viscosity | | | Pa · s | 545 | 576 | 546 | 540 |
| Izod Impact | Ductility | 100 | % | 100 | 100 | 100 | 100 |
| 23° C. | Impact Strength | | J/m | 738 | 746 | 670 | 709 |
| Izod Impact | Ductility | 100 | % | 0 | 100 | 100 | 100 |
| 0° C. | Impact Strength | | J/m | 216 | 647 | 550 | 623 |
| Izod | Ductility | 100 | % | 0 | 0 | 0 | 0 |
| Impact −20° C. | Impact Strength | | J/m | 152 | 188 | 181 | 242 |
| Multi-axial | Ductility | 100 | % | 100 | 100 | 100 | 100 |
| Impact 23° C. | Energy, Total | | J | 61.5 | 62.9 | 53.6 | 57.1 |
| Multi-axial | Ductility | 100 | % | 100 | 100 | 100 | 100 |
| Impact 0° C. | Energy, Total | | J | 65.2 | 70.2 | 59.8 | 72.1 |
| Multi-axial | Ductility | 100 | % | 100 | 100 | 100 | 100 |
| Impact −20° C. | Energy, Total | | J | 65 | 66.4 | 66.5 | 67.3 |

Heat aging 140° C., 500 Hr

| | | | | | | | |
|---|---|---|---|---|---|---|---|
| Izod Impact 23° C. | Ductility | 100 | % | 0 | 100 | 100 | 100 |
| | Impact Strength | | J/m | 172 | 553 | 397 | 500 |
| Multi-axial | Ductility | 100 | % | 100 | 100 | 100 | 100 |
| Impact 23° C. | Energy, Total | | J | 65 | 60 | 56.1 | 54.7 |

Heat aging 140° C., 1000 Hr

| | | | | | | | |
|---|---|---|---|---|---|---|---|
| Izod Impact 23° C. | Ductility | 100 | % | 0 | 100 | 0 | 100 |
| | Impact Strength | | J/m | 142 | 394 | 159 | 396 |
| Multi-axial | Ductility | 100 | % | 60 | 100 | 100 | 100 |
| Impact 23° C. | Energy, Total | | J | 61.2 | 59.8 | 53.6 | 51.7 |

Hydroaging, 80 C./80% RH, 500 Hr

| | | | | | | | |
|---|---|---|---|---|---|---|---|
| Izod Impact 23° C. | Ductility | 100 | % | 0 | 0 | 0 | 100 |
| | Impact Strength | | J/m | 111 | 141 | 94.1 | 283 |
| Multi-axial | Ductility | 100 | % | 100 | 100 | 100 | 100 |
| Impact 23° C. | Energy, Total | | J | 55.7 | 57.7 | 53.9 | 50.5 |

### Discussion

The results shown in Tables 5 (Comparative Examples 9-12) illustrate that use of the combination of PC-Siloxane and a random terpolymer of ethylene (E), methyl acrylate (MA) and glycidyl methacrylate (GMA) (in the form of PC/EMA-GMA concentrate) outside of a relatively narrow range does not meet the minimum targeted performance properties; namely these compositions did not exhibit the following combination of properties: (a) 100% ductility in both notched Izod impact test as well as multi-axial impact test at 23° C., 0° C., and −20° C. after molding, (b) 100% ductility in both notched Izod impact test as well as multi-axial impact test after heat aging at 140° C. for up to 1000 hours, and (c) 100% ductility in both notched Izod impact test as well as multi-axial impact test after hydro aging at 80° C. and 80% humidity for up to 500 hours.

As shown in Table 5, when the amount of PC-Siloxane and PC/E-MA-GMA concentrate were less than 24 wt. % and 10 wt. % respectively (CE 9 to CE 12), the compositions failed to achieve 100% ductility in notched Izod impact test at −20° C. after molding. When there was 7 wt. % PC-Siloxane and 10 wt. % PC/EMA-GMA in the composition (CE9), the material was brittle after heat aging at 140° C. and hydroaging at 80° C. and 80% R.H. in the notched Izod impact test. When there was 13% of the PC-Siloxane and 10 wt. % PC/E-MA-GMA in the composition (CE10), the material was brittle after hydroaging at 80° C. and 80% R.H. in the notched Izod impact test. When there was 24 wt. % the PC-Siloxane and 3 wt. % PC/EMA-GMA in the composition (CE10), the material was brittle after heat aging at 140° C. for 1000 Hr and hydroaging at 80° C. and 80% R.H. in the notched Izod impact test.

While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermoplastic composition comprising, based on the total weight of the composition:
(a) 20 to 60 wt. % of polycarbonate;
(b) 15 to 50 wt. % of polyester comprising 15 to 45 wt. % of polyethylene terephthalate and 0 to 12 wt. % of polybutylene terephthalate;
(c) 20 to 35 wt. % of organopolysiloxane-polycarbonate block copolymer comprising 10 to 40 wt. % of polydiorganosiloxane units;
(d) 2 to 20 wt. % of copolyestercarbonate;
(e) 0.5 to 6 wt. % of epoxy-functional block copolymer, wherein the wt. % of each of components (a) to (e) is based on the total weight of components (a) to (e), and the total weight of components (a) to (e) is at least 75 wt. % of the total composition;
(f) 0.1 to 10 wt. % of additives, based on the total weight of the composition, comprising at least one compound selected from the group consisting of antioxidants, light stabilizers, colorants, quenchers, and mold release agents; and
(g) 0 to 15 wt. % of filler, based on the total weight of the composition.

2. The composition of claim 1, wherein an article made from the composition retains 100% ductility after exposure to 140° for 1,000 hours.

3. The composition of claim 1, wherein an article made from the composition retains 100% ductility after exposure to 80° C. and 80% relative humidity for 500 hours.

4. The composition of claim 1, wherein an article made from the composition exhibits: (i) 100% ductility in both notched Izod impact test as well as multi-axial impact test at 23° C., 0° C., and −20° C. after molding, (ii) 100% ductility in both notched Izod impact test as well as multi-axial impact test after heat aging at 140° C. for up to 1000 hours, and (iii) 100% ductility in both notched Izod impact test as well as multi-axial impact test after hydroaging at 80° C. and 80% humidity for up to 500 hours.

5. The composition of claim 1, wherein the composition exhibits a notched Izod impact strength of greater than 500 J/m, measured at 23° C. in accordance with ASTM D256 on a sample bar molded from the composition and having a thickness of 3.2; a notched Izod impact strength of greater than 500 μm measured at −20° C. in accordance with ASTM D256 on a sample bar molded from the composition and having a thickness of 3.2; and, after heat aging at 140° C. for up to 1000 hours, a notched Izod impact strength of greater than 500 J/m measured at 23° C. in accordance with ASTM D256 on a sample bar molded from the composition and having a thickness of 3.2.

6. The composition of any of claim 1, wherein the poly(ethylene terephthalate) has an intrinsic viscosity of 0.8 to 1.4 dl/g.

7. The composition of claim 1, wherein the composition comprises poly(butylene terephthalate) that is optionally derived from a recycled polyester.

8. The composition of claim 1, wherein the poly(ethylene terephthalate) is present in the amount of 20 to 40 wt. % and the poly(butylene terephthalate) is present in the amount of 1 to 10 wt. %.

9. The composition of any of claim 1, wherein the organopolysiloxane-polycarbonate block copolymer is of the formula 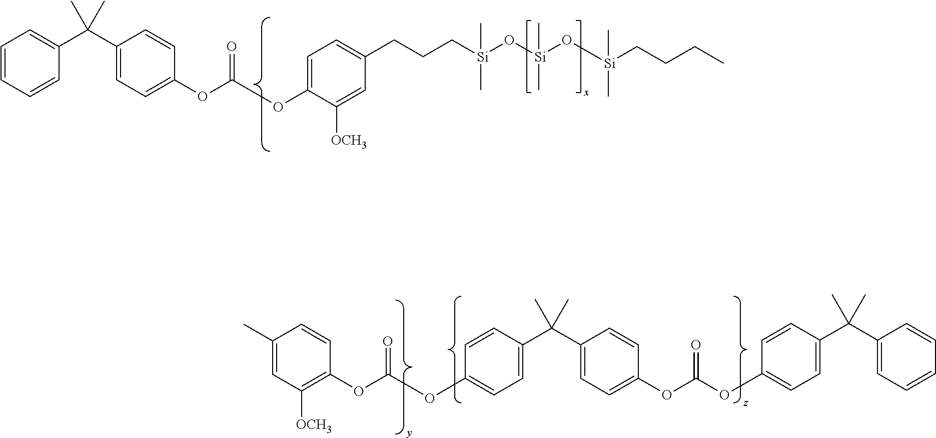
wherein x=30-60, y is 1-5, and z is 70-130 such that the organopolysiloxane-polycarbonate block copolymer comprises 15 to 25 wt. % of polydiorganosiloxane units.

10. The composition of claim 1 wherein at least a portion of the organopolysiloxanes-polycarbonate block copolymer is end-capped with para-cumylphenol.

11. The composition of claim 1, wherein the epoxy-functional block copolymer comprises olefinic units, (meth)acrylate ester units and glycidyl(meth)acrylate units.

12. The composition of claim 11, wherein the epoxy-functional block copolymer is an ethylene-glycidyl(meth)acrylate-alkyl acrylate impact modifier.

13. The composition of claim 1, wherein the epoxy-functional block copolymer is present in an amount from 1 to 5 wt. % and the organopolysiloxane-polycarbonate block copolymer is present in an amount from greater than 20 to less than 30 wt. %.

14. The composition of claim 1, further comprising a thermal stabilizer, light stabilizer, lubricant or mold release agent, dye or pigment, or a combination thereof.

15. The composition of claim 1, further comprising one or more optional additives selected from the group consisting of pentaerythritol betalaurylthiopropionate, phosphorous acid ester, mono zinc phosphate, pentaerythritrol tetrastearate, 2-(2′hydroxy-5-T-octylphenyl)-benzotriazole, and combinations thereof.

16. A thermoplastic composition comprising, based on the total weight of the composition:
(a) 25 to 45 wt. % of polycarbonate;
(b) 15 to 50 wt. % of polymer comprising 20 to 40 wt. % of polyethylene terephthalate and 0 to 10 wt. % of polybutylene terephthalate;
(c) 20 to 30 wt. % of organopolysiloxane-polycarbonate block copolymer comprising from 15 to 25 wt. % of polydiorganosiloxane units;
(d) 5 to 15 wt. % of copolyestercarbonate;
(e) 1 to 5 wt. % of epoxy-functional block copolymer comprising glycidyl methacrylate units, wherein the weight percent of each of components (a) to (e) is based on the total weight of components (a) to (e), and the total weight of components (a) to (e) is at least 80 wt. % of the total composition;
(f) 0.1 to 5 wt. % of additives, based on the total weight of the composition, comprising at least one compound selected from the group consisting of antioxidants, light stabilizers, colorants, quenchers, and mold release agents;
(g) 0 to 10 wt. % of filler, based on the total weight of the composition;
wherein the composition exhibits: (i) 100% ductility in both notched Izod impact test as well as multi-axial impact test at 23° C., 0° C., and −20° C. after molding, (ii) 100% ductility in both notched Izod impact test as well as multi-axial impact test after heat aging at 140° C. for up to 1000 hours, and (iii) 100% ductility in both notched Izod impact test as well as multi-axial impact test after hydroaging at 80° C. and 80% humidity for up to 500 hours.

17. A thermoplastic composition comprising, based on the total weight of the composition:
(a) 25 to 45 wt. % of bisphenol A polycarbonate;
(b) 20 to 40 wt. % of polyester comprising 20 to 30 wt. % of polyethylene terephthalate and 1 to 10 wt. % of polybutylene terephthalate;
(c) about 22 to 27 wt. % of organopolysiloxane-polycarbonate block copolymer comprises from about 15 to 25 wt. % of polydiorganosiloxane units and having the formula: 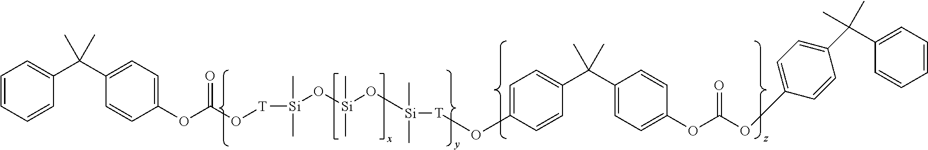
wherein x is 30-60, y is 1-5, and z is 70-30, and T is a divalent C₃₋₃₀ linking group;
(d) 5 to 15 wt. % of copolyestercarbonate;
(e) 2 to 4 wt. % of epoxy-functional block copolymer comprising units derived from ethylene, glycidyl methacrylate, and C₁₋₄ alkyl (meth)acrylate, wherein the wt. % of each of components (a) to (e) is based on the total weight of components (a) to (e), and the total weight of components (a) to (e) is at least 85 wt. % of the total composition;
(f) 2 to 10 wt. % of additives, based on the total weight of the composition, comprising at least one compound selected from the group consisting of antioxidants, light stabilizers, colorants, quenchers, and mold release agents;
(g) 0 to 10 wt. % of filler, based on the total weight of the composition;
wherein the composition exhibits a ductility of 100% in both notched Izod impact test as well as multi-axial impact test at 23° C., 0° C., and −20° C. after molding; 100% ductility in both notched Izod impact test as well as multi-axial impact test after heat aging at 140° C. for up to 1000 hours; and 100% ductility in both notched Izod impact test as well as multi-axial impact test after hydroaging at 80° C. and 80% humidity for up to 500 hours; and
a notched Izod impact strength of greater than 600 J/m, measured at 23° C. in accordance with ASTM D256 on a sample bar molded from the composition and having a thickness of 3.2; a notched Izod impact strength of greater than 500 μm measured at −20° C. in accordance with ASTM D256 on a sample bar molded from the composition and having a thickness of 3.2; and, after heat aging at 140° C. for up to 1000 hours, a notched Izod impact strength of greater than 540 J/m, measured at 23° C. in accordance with ASTM D256 on a sample bar molded from the composition and having a thickness of 3.2.

18. An article comprising the composition of claim 1.

19. The article of claim 18, wherein the article is component of an automotive vehicle.

20. The article of claim 18, wherein the article comprises less than 5 wt. % of fiber filler and is used in the exterior housing of an automotive vehicle.
